(19) United States
(12) Patent Application Publication
(10) Pub. No.: US 2025/0313655 A1
(43) Pub. Date: Oct. 9, 2025

(54) ACRYLIC EMULSIONS WITH MORE THAN ONE MICRON SIZE POLYMER PARTICLES

(71) Applicant: BASF SE, Ludwigshafen am Rhein (DE)

(72) Inventor: Senthilkumar RENGASAMY, Charlotte, NC (US)

(21) Appl. No.: 18/863,140

(22) PCT Filed: May 4, 2023
(86) PCT No.: PCT/US2023/020943

§ 371 Date: Nov. 5, 2024

Related U.S. Application Data
(60) Provisional application No. 63/339,022, filed on May 6, 2022.

(51) Int. Cl. C08F 2/01; C08F 2/24; C08F 2/38; C08F 6/00; C08F 212/08; C08F 220/14; C08F 220/18

(52) U.S. Cl. CPC C08F 2/01; C08F 2/24; C08F 2/38; C08F 6/006; C08F 212/08; C08F 220/14; C08F 220/1804; C08F 220/1808

(57) ABSTRACT

Disclosed herein are acrylic emulsions with more than one micron size polymer particles, and methods of synthesizing and using the emulsion compositions.

### FIELD OF THE DISCLOSURE

This disclosure relates generally to acrylic emulsions, and more particularly to acrylic emulsions with more than one micron size polymer particles, and to methods of synthesizing and using the emulsion compositions.

### BACKGROUND OF THE DISCLOSURE

Aqueous based coatings, such as for example latex or emulsion polymer coatings, constitute a significant segment of all coatings in use today. Aqueous based coatings present advantages over conventional oil-based coatings because they contain fewer undesirable volatile organic solvents and therefore are more environmentally friendly. These polymeric products are dispersed in an aqueous medium and are stable in this condition but can form continuous coating film upon removal of the water.

### SUMMARY OF THE DISCLOSURE

Disclosed herein are aqueous dispersions of an acrylic polymer comprising particles of the acrylic polymer dispersed in an aqueous medium, wherein the particles of the acrylic polymer have a measured d(0.1) value of 1 μm or more. In another aspect, provided herein are processes for making the aqueous dispersion of acrylic polymers described here. In some embodiments, the aqueous polymer dispersion is prepared using a free radical emulsion polymerization process. In some embodiments, the free radical emulsion polymerization process is performed in a dual feed reactor.

### BRIEF DESCRIPTION OF THE DRAWINGS

The accompanying drawings, which are incorporated in and constitute a part of this specification, illustrate several embodiments of the disclosure and together with the description, serve to explain the principles of the disclosure.

FIG. 1 provides a schematic of the dual feed polymerization reactor used in the syntheses of the acrylic emulsions of the present disclosure.

### DETAILED DESCRIPTION

The term “comprising” and variations thereof as used herein is used synonymously with the term “including” and variations thereof and are open, non-limiting terms. Although the terms “comprising” and “including” have been used herein to describe various embodiments, the terms “consisting essentially of” and “consisting of” can be used in place of “comprising” and “including” to provide for more specific embodiments and are also disclosed. As used in this disclosure and in the appended claims, the singular forms “a”, “an”, “the”, include plural referents unless the context clearly dictates otherwise. The disclosure of percentage ranges and other ranges herein includes the disclosure of the endpoints of the range and any integers provided in the range.

I. Acrylic Emulsions with More than 1 Micron Size Polymer Particles

The present disclosure provides acrylic emulsions with more than one micron size polymer particles, as well as synthesis methods for the emulsions. The resulting emulsion polymers demonstrate high shelf-life stability which translates to use in numerous coatings or adhesive formulations as a stand-alone polymer or by blending with other co-binders.

A typical formulation for the emulsions of the present disclosure may comprise a copolymer, a chain transfer agent, and a surfactant. Other ingredients may be added to harden or soften the product. Colorants may also be added. Defoamers may be added.

The acrylic emulsions of the present invention may be acrylic or styrene-acrylic copolymers. Suitable monomers employed in the preparation of the emulsion include, but are not limited to, acrylic acid in an amount of from about 0%-2.0% by weight, methacrylic acid in an amount of from about 0%-2.0% by weight, styrene in an amount of from about 0%-55% by weight, hydroxyethylmethacrylate in an amount of from about 0%-5% by weight, butyl acrylate in an amount of from about 0%-48% by weight, butyl methacrylate in an amount of from about 0%-25% by weight, methyl methacrylate in an amount of from about 0%-55% by weight, diacetone acrylamide in an amount of from about 0%-5% by weight, methacrylate in an amount of from about 0%-15% by weight, ethyl acrylate in an amount of from about 0%-15% by weight, glycidyl methacrylate in an amount of from about 0%-5% by weight, 2-ethylhexyl acrylate in an amount of from about 0%-40% by weight, isobutyl acrylate in an amount of from about 0%-10% by weight, and isobutyl methacrylate in an amount of from about 0%-10% by weight, based on the total weight of the composition.

In some embodiments, the copolymer may be a carboxylic acid-functional resin. In some embodiments, the carboxylic acid-functional resin may be an alkali soluble resin. In other words, the carboxylic acid-functional resin may react with alkali materials to form ion salts at the carboxylate groups of the polymer, thereby enhancing the water solubility characteristics of the resin. Suitable monomers for preparation of the carboxylic acid-functional resin and the low molecular weight copolymer include monomers such as acrylic acid, methacrylic acid, itaconic acid, maleic acid, fumaric acid, crotonic acid, acrylic anhydride, methacrylic anhydride, itaconic anhydride, maleic anhydride, fumaric anhydride, crotonic anhydride, styrene, methyl styrene, alpha-methyl styrene, ethyl styrene, isopropyl styrene, tertiary-butyl styrene, ethyl methacrylate, methyl methacrylate, butyl acrylate, butyl methacrylate, 2-ethylhexyl acrylate, ethyl acrylate, vinyl acetate, methyl acrylate, open-chain conjugated dienes, 2-hydroxyethyl methacrylate, 2-hydroxyethyl acrylate, methylol acrylamide, glycidyl acrylate, glycidyl methacrylate, vinyl esters, vinyl chloride, or mixtures of any two or more such monomers. In some embodiments, the carboxylic acid-functional support resin includes polymerized monomers of one or more of ethyl methacrylate, methyl methacrylate, butyl acrylate, butyl methacrylate, 2-ethylhexyl acrylate, ethyl acrylate, vinyl acetate, methyl acrylate, 2-hydroxyethyl methacrylate, 2-hydroxyethyl acrylate, glycidyl acrylate, glycidyl methacrylate, or mixtures of any two or more such monomers. In one embodiment, the carboxylic acid-functional resin includes polymerized monomers of one or more acrylic acid, ethyl methacrylate, methyl methacrylate, butyl acrylate, butyl methacrylate, 2-ethylhexyl acrylate, ethyl acrylate, vinyl acetate, methyl acrylate, 2-hydroxyethyl methacrylate, 2-hydroxyethyl acrylate, glycidyl acrylate, glycidyl methacrylate, styrene, methyl styrene, alpha-methyl styrene, diacetone acrylamide, ureido methacrylate, or a mixture of any two or more such monomers. In some embodiments, the carboxylic acid-functional resin may include a co-polymer including two or more of styrene, methyl methacrylate, and acrylic acid. In some embodiments, the carboxylic acid-functional support resin may include a copolymer of acrylic acid and styrene.

The polymer or polymers used within the emulsions may have a glass transition temperature (Tg) for the individual polymer from −60° C. to 130° C. or any subrange or value within this range. For example, any given polymer within an emulsion may have a Tg from −60° C. to 100° C., from −60° C. to 75° C., from −60° C. to 50° C., from −15° C. to 50° C., from −15° C. to 45° C., from −15° C. to 40° C., from −15° C. to 35° C., from −15° C. to 30° C., from −15° C. to 25° C., from −15° C. to 20° C., from −15° C. to 15° C., from −15° C. to 10° C., from −15° C. to 5° C., from −15° C. to 0° C., from 0° C. to 50° C., from 0° C. to 45° C., from 0° C. to 40° C., from 0° C. to 35° C., from 0° C. to 30° C., from 0° C. to 20° C., from 0° C. to 15° C., from 0° C. to 10° C., from 10° C. to 50° C., from 10° C. to 45° C., from 10° C. to 40° C., from 10° C. to 35° C., from 10° C. to 30° C., from 10° C. to 25° C., from 10° C. to 20° C., or any range including any two of these values as endpoints

The emulsion or combination of polymers may have a glass transition temperature (Tg) for the individual polymer from −60° C. to 130° C. or any subrange or value within this range. For example, any given polymer within an emulsion may have a Tg from −60° C. to 100° C., from −60° C. to 75° C., from −60° C. to 50° C., from −15° C. to 50° C., from −15° C. to 45° C., from −15° C. to 40° C., from −15° C. to 35° C., from −15° C. to 30° C., from −15° C. to 25° C., from −15° C. to 20° C., from −15° C. to 15° C., from −15° C. to 10° C., from −15° C. to 5° C., from −15° C. to 0° C., from 0° C. to 50° C., from 0° C. to 45° C., from 0° C. to 40° C., from 0° C. to 35° C., from 0° C. to 30° C., from 0° C. to 20° C., from 0° C. to 15° C., from 0° C. to 10° C., from 10° C. to 50° C., from 10° C. to 45° C., from 10° C. to 40° C., from 10° C. to 35° C., from 10° C. to 30° C., from 10° C. to 25° C., from 10° C. to 20° C., or any range including any two of these values as endpoints.

The polymers may be formed from emulsion-polymerizable monomers. Emulsion-polymerizable monomers are known in the art, see e.g. U.S. Pat. Nos. 4,820,762; 7,253,218; 7,893,149; and U.S. Patent Publication No. 2015/0166803. The emulsion polymerizable monomer may include an ethylenically unsaturated monomer. In some embodiments, emulsion polymerizable monomer may include at least one ethylenically unsaturated nonionic monomer. By “nonionic monomer” herein is meant that the copolymerized monomer residue does not bear an ionic charge between pH 1 and 14. Suitable ethylenically unsaturated nonionic monomers include, but are not limited to, (meth)acrylic ester monomers including methyl acrylate, ethyl acrylate, butyl acrylate, 2-ethylhexyl acrylate, decyl acrylate, lauryl acrylate, methyl methacrylate, butyl methacrylate, isodecyl methacrylate, lauryl methacrylate, hydroxyethyl methacrylate, hydroxypropyl methacrylate; (meth)acrylonitrile; (meth)acrylamide; ureido-functional monomers; monomers bearing acetoacetate-functional groups; styrene and substituted styrenes; butadiene; ethylene, propylene, .alpha.-olefins such as 1-decene; vinyl acetate, vinyl butyrate and other vinyl esters; and vinyl monomers such as vinyl chloride, vinylidene chloride.

The emulsion-polymerizable monomer may include acrylate monomers, methacrylate monomers, styrene monomers, or a mixture of any two or more thereof. In some embodiments, the emulsion polymerizable monomer does not include styrene monomers.

In some embodiments, the at least one emulsion polymerizable monomer may be a C₁-C₄ acrylate, a C₁-C₄ (meth)acrylate, or a mixture of any two or more thereof. In some embodiments, the emulsion-polymerizable monomer may be n-butyl acrylate, 2-ethylhexyl acrylate, methyl acrylate, methyl methacrylate, styrene, ethyl acrylate, or a mixture of any two or more thereof.

In some embodiments, the emulsion polymerizable polymer may include one or more keto-functional monomers. Examples of keto-functional monomers include diacetone acrylamide, diacetone methacrylamide, diacetone acrylate, diacetone methacrylate, acetoacetoxymethyl (meth)acrylate, 2-(acetoacetoxy)ethyl (meth)acrylate, 2-acetoacetoxypropyl(meth)acrylate, butanediol-1,4-acrylate-acetylacetate, vinyl methyl ketone, vinyl ethyl ketone, and vinyl isobutyl ketone, allyl acetoacetate, vinyl acetoacetate, or vinyl acetoacetamide. In one embodiment, the emulsion polymerizable polymer includes a repeat unit derived from diacetone acrylamide.

The emulsions may be formed through an emulsion polymerization reaction, which may involve at least one emulsion polymerizable monomer, a low molecular weight copolymer, and other ingredients and/or reagents, such as an initiator. In some embodiments, the emulsion polymerization occurs in a dual-feed reactor.

The initiator may be a water-soluble compound for ready mixing and blending with the emulsions. Non-limiting examples of water-soluble initiators for the emulsion polymerization include ammonium salts and alkali metal salts of peroxydisulfuric acid, e.g., sodium peroxodisulfate, hydrogen peroxide or organic peroxides, e.g., tert-butyl hydroperoxide. The initiator may be a thermal initiator. Suitable initiators include, but are not limited to 2,2′-azobis(2-methylpropionamidine) dihydrochloride, ammonium persulfate, sodium persulfate, and potassium persulfate. Also suitable are reduction-oxidation (redox) initiator systems. The redox initiator systems consist of at least one, usually inorganic, reducing agent and an organic or inorganic oxidizing agent. The oxidizing component comprises, for example, the emulsion polymerization initiators already identified above. The reducing components comprise, for example, alkali metal salts of sulfurous acid, such as, for example sodium sulfite, sodium hydrogensulfite, alkali metal salts of disulfurous acid such as sodium disulfite, bisulfite addition compounds with aliphatic aldehydes and ketones, such as acetone bisulfite, or reducing agents such as hydroxymethanesulfinic acid and its salts, or ascorbic acid. The redox initiator systems can be used along with soluble metal compounds whose metallic component is able to exist in a plurality of valence states. Typical redox initiator systems are, for example, ascorbic acid/iron (II) sulfate/sodium peroxydisulfate, tert-butyl hydroperoxide/sodium disulfite, tert-butyl hydroperoxide/Na hydroxymethanesulfinic acid. The individual components, the reducing component for example, may also be mixtures, an example being a mixture of the sodium salt of hydroxymethanesulfinic acid and sodium disulfite. The stated compounds are used usually in the form of aqueous solutions, with the lower concentration being determined by the amount of water that is acceptable in the dispersion, and the upper concentration by the solubility of the respective compound in water. Generally speaking, the concentration is 0.1% to 30% by weight, preferably 0.5% to 20% by weight, more preferably 1.0% to 10% by weight, based on the solution. The amount of the initiators is generally 0.1% to 10% by weight, preferably 0.5% to 5% by weight, based on the monomers to be polymerized. It is also possible for two or more different initiators to be used in the emulsion polymerization.

In some embodiments, an initiator may be ammonium persulfate and an oxidizer may be t-butyl hydroperoxide. In such case, a weight ratio between ammonium persulfate and t-butyl hydroperoxide may range from 40:1 to 2:1 or from 30:1 to 4:1 or any subrange or value within these ranges.

In some embodiments, the emulsion includes one or more chain transfer agents to control molecular weight, branching and/or gel formation. Exemplary chain transfer agents include, but are not limited to, isooctyl mercaptopropionate (IOMPA), butylmercaptopropionate, 2-ethyl hexylmercaptopropionate, tertiary dodecylmercaptan, and thioglycerol.

In general, the amounts of the chain transfer agents employed can be varied from 0.01% to 1% by weight, based on the total amount of the monomers to be polymerized.

The polymer emulsions described herein may also contain a surfactant. In some embodiments, the surfactant is anionic or non-ionic. In some embodiments, the surfactant contains one or more fatty alcohol alkoxylates. In further embodiments, the one or more fatty alcohol alkoxylates are fatty alcohol ethoxylates, fatty alcohol propoxylates, or any combination thereof. In some embodiments, the surfactant contains one or more ethylene oxide/propylene oxide block copolymers. In some embodiments, the surfactant contains one or more fatty alcohol ethoxylates. In some embodiments, the surfactant contains one or more alkylsulfosuccinate ethoxylates. In some embodiments, the surfactant contains one or more fatty alcohols having an alkyl chain length of about 12 to about 18 carbons; and a degree of ethoxylation of about 10 to about 80 molar ethylene oxide units. In some embodiments, the surfactant includes non-ionic surfactants. In some embodiments, the surfactant includes anionic surfactants. In some embodiments, the anionic surfactant includes one or more alkyl sulfonates, alkyl benzene sulfonates, alkyl sulfates, alkyl benzene sulfates, phosphates, phosphinates, fatty carboxylates, or any combination of two or more thereof.

In general, the amounts of the surfactants employed can be varied from 0.3% to 1% by weight, based on the total amount of the monomers to be polymerized.

The polymer compositions described herein may contain other materials such as, but not limited to, other aqueous resin solutions, rheology modifiers, wetting agents, defoamers, thickeners, stabilizers, buffering agents, salts, preservatives, fire retardants, biocides, corrosion inhibitors, cross-linkers, lubricants, colorants, dyes, waxes, perfumes, and fillers.

As described herein, the acrylic or styrene-acrylic emulsion dispersion particles may have a d(0.1) of 0.1 μm or greater, 0.5 μm or greater, or 1 μm or greater. The large and multimode particle size distribution is aided by flooding the reactor with monomer and seed polymer at the initial stage of polymerization thereby creating a scarcity for micelles. Additionally, the ramp-up and ramp-down power feeding of surfactants and monomers promotes large and multimode particle sizes.

### II. Methods of Making Emulsions

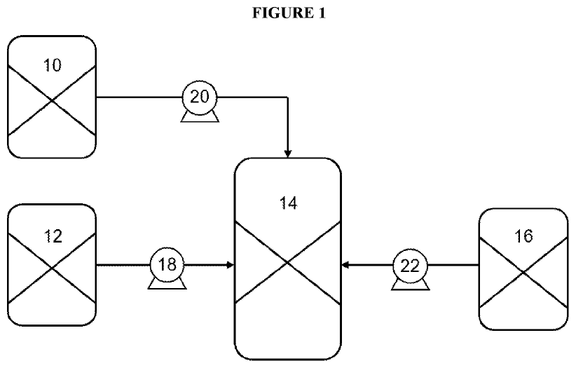

The emulsions of the present disclosure may be formed through an emulsion polymerization, which relies on the use of small molecule surfactants containing a polar/hydrophilic group and a nonpolar/hydrophobic group. The amphiphilic nature of these materials allows them to effectively stabilize heterogenous solutions (i.e. polymer particles in water). The emulsion polymerization reactions of the present disclosure may be performed in a dual feed reactor such as the one depicted in FIG. 1. The reactor may be equipped with a water bath, mechanical stirrer, temperature control probes, feeding tubes for monomer addition, feeding tubes for initiator addition, and reflux condensers. In general, each tank is charged with the contents listed below in Table 1.

TABLE 1
Charges for different vessels in dual
feed reactor depicted in FIG. 1.

| Vessel | Charge |
|---|---|
| Tank 12 | Pre emulsion (DI-Water + Surfactant + |
| | Monomer A + Optionally Chain Transfer |
| | Agent |
| Tank 16 | Neat monomer (Monomer B) or Pre |
| | emulsion (DI-Water + Surfactant + |
| | Monomer B) |
| Tank 10 | Initiator (DI-Water + Initiator + Optionally |
| | Buffer) |
| Reactor 14 | Reactor Charge (DI-Water + Surfactant + |
| | Seed + Acid Monomer |

Initially, reactor 14 is charged with DI-water which is then heated to 85° C. Acid monomer at 80° C. is added to reactor 14 at one shot followed by an initial initiator shot from tank 10 which is pumped into reactor 14 via pump 20. Then, the pre-emulsion feed in tank 12 comprising DI-water, surfactant, Monomer A, and optionally a chain transfer reagent is pumped through pump 18 to feed into reactor 14. Simultaneously, the neat monomer feed in tank 16 comprising Monomer A is pumped through pump 22 into reactor 14. After 15 minutes of pre-emulsion, a second charge of initiator feed from tank 10 is pumped into reactor 14. The total feeding time is three hours. At the end of pre-emulsion, the neat monomer and initiator feeds hold the reactor at 85° C. for 30 minutes and then flush water is added to reduce the temperature to 70° C. After completion of the chemical stripping process, reactor 14 is cooled to room temperature before the polymer finished polymer is filtered into a storage container.

As described herein, the free radical initiators can be water-soluble initiators. Examples of such water-soluble initiators can include but are not limited to, persulfates such as sodium persulfate (Na₂S₂O₈) and potassium persulfate; peroxides such as hydrogen peroxide and tert-butyl hydroperoxide (t-BHP); and azo compounds such as VAZO™ initiators, commercially available from The Chemours Company. They can be used alone or in combination with one or more reducing agents or activators, for example, bisulfites, metabisulfites, ascorbic acid, erythorbic acid, sodium formaldehyde sulfoxylate, ferrous sulfate, ferrous ammonium sulfate, and ferric ethylenediamine tetraacetic acid.

In general, the amounts of the free-radical initiators employed can be varied from 0.1% to 1% by weight, based on the total amount of the monomers to be polymerized.

The coating formulations described herein can be used to prepare products, including coatings, adhesives, and the like.

The examples below are intended to further illustrate certain aspects of the methods and compositions described herein and are not intended to limit the scope of the claims.

### EXAMPLES

The following examples are put forth so as to provide those of ordinary skill in the art with a complete disclosure and description of how the compositions and/or methods claimed herein are made and evaluated and are intended to be purely exemplary and are not intended to limit the scope of the disclosure. Unless indicated otherwise, parts are parts by weight, temperature is in ° C. or is at ambient temperature, and pressure is at or near atmospheric.

The particle size distribution percentiles are denoted by the letter “d” followed by the % value. Thus, d(0.1) or d10=1.107 uM, d(0.5) or d(50)=3.79 uM & d(0.9) 0r d(90)=7.094 uM means that 10% of the sample is smaller 1.107 uM, 50% of sample is smaller than 3.79 uM and 90% of sample is smaller than 7.094 uM.

### Example 1: Synthesis of Acrylic Emulsions

Initially, the polymerization reactor was charged with a required amount of DI-water, about 25% of the total surfactant amount and seed polymer. The reactor was heated to 85° C. and at 80° C. acid monomer was added at one shot. Then at 85° C. an initial initiator shot (about 25% of total initiator solution) was instantly added. After the initiator shot, pre-emulsion neat monomer feeds were started simultaneously. After 15 minutes of pre-emulsion and neat monomer feeds, the second charge of initiator feed was started. The total feeding (Neat Monomer+Pre-emulsion+Initiator) time was 3 hours. At the end of pre-emulsion, the neat monomer and initiator feed held the reactor at 85° C. for 30 minutes and then flush water was added to reduce the reactor temperature to 70° C. At 70° C., delayed oxidizer and reducer feeds were started to reduce the residual monomers. After the completion of chemical strip process, the reaction was cooled to room temperature. Finally post addition solution was added and the reactor mixed the contents for 15 minutes before filtering the polymer in storage container.

TABLE 2
List of acrylic emulsion formulations,

| | | Acid | | |
|---|---|---|---|---|
| Formulaiton | Surfactant | Monomer | Tank-1 | Tank-2 |
| 1 | Polystep LAS40 | Methacrylic | DI-Water + Surfactant + Butylacrylate + | Methylmethacrylate |
| | | Acid | t-Dodecylmercaptan | |
| 2 | Polystep LAS40 | Methacrylic | DI-Water + Surfactant + Butylacrylate | Styrene |
| | | Acid | | |
| 3 | Polystep LAS40 | Methacrylic | DI-Water + Surfactant + Butylacrylate + | Styrene |
| | | Acid | Ethyldiglycol Acrylate + | |
| | | | t-Dodecylmercaptan | |
| 4 | Polystep LAS40 | Methacrylic | DI-Water + Surfactant + Butylacrylate + | Methylmethacrylate |
| | | Acid | Diacetoneacrylamide + | |
| | | | t-Dodecylmercaptan | |
| 5 | Polystep LAS40 | Methacrylic | DI-Water + Surfactant + Butylacrylate + | Methylmethacrylate |
| | | Acid | Methylmethacrylate + Glycidylmethacrylate + | |
| | | | t-Dodecylmercaptan | |
| 6 | Polystep LAS40 | Methacrylic | DI-Water + Surfactant + Butylacrylate + | Methylmethacrylate + |
| | | Acid | Methylmethacrylate + Glycidylmethacrylate + | Triethoxyvinyl Silane |
| | | | t-Dodecylmercaptan | |
| 7 | Polystep LAS40 | Methacrylic | DI-Water + Surfactant + Butylacrylate + | Methylmethacrylate |
| | | Acid | Diacetoneacrylamide + Isooctyl-3- | |
| | | | mercaptopropianate | |
| 8 | Polystep LAS40 | Methacrylic | DI-Water + Surfactant + Butylacrylate + | Methylmethacrylate |
| | | Acid | Butylmethacryalte + t-Dodecylmercaptan | |
| 9 | Polystep LAS40 + | Methacrylic | DI-Water + Surfactant + Butylacrylate + | DI-Water + |
| | Polystep A-16-22 + | Acid | Tert-Butylacrylate + t-Dodecylmercaptan | Surfactant + |
| | Lutensol XP-80 | | | Methylmethacrylate |
| 10 | Polystep LAS40 + | Methacrylic | DI-Water + Surfactant + Butylacrylate + | DI-Water + |
| | Polystep A-16-22 + | Acid | Ureidomethacrylate + t-Dodecylmercaptan | Surfactant + |
| | Lutensol XP-80 | | | Methylmethacrylate |
| 11 | Polystep LAS40 + | Methacrylic | DI-Water + Surfactant + Butylacrylate + | DI-Water + |
| | Polystep A-16-22 + | Acid | Cyclohexyl methacrylate + t-Dodecylmercaptan | Surfactant + |
| | Lutensol XP-80 | | | Methylmethacrylate |
| 12 | Polystep LAS40 + | Methacrylic | DI-Water + Surfactant + Butylacrylate + | DI-Water + |
| | Polystep A-16-22 + | Acid | 2-Ethylhexyl Acrylate + t-Dodecylmercaptan | Surfactant + |
| | Lutensol XP-80 | | | Methylmethacrylate |
| 13 | Polystep LAS40 + | Methacrylic | DI-Water + Surfactant + Butylacrylate + | DI-Water + Surfactant + |
| | Polystep A-16-22 + | Acid | Styrene + t-Dodecylmercaptan | Methylmethacrylate + |
| | Lutensol XP-80 | | | Isobornylmethacrylate |
| 14 | Polystep LAS40 + | Methacrylic | DI-Water + Surfactant + Butylacrylate + | DI-Water + |
| | Polystep A-16-22 + | Acid | Isobornylmethacrylate + t-Dodecylmercaptan | Surfactant + |
| | Lutensol XP-81 | | | Methylmethacrylate |

TABLE 3
Malvern Particle Size Distribution of Formulations 1-14.

| | Particle Size Distribution | | |
|---|---|---|---|
| Formulation # | d(0.1) | d(0.5) | d(0.9) |
| 1 | 1.107 | 3.79 | 7.094 |
| 2 | 0.925 | 1.773 | 9.042 |
| 3 | 0.888 | 1.314 | 2.005 |
| 4 | 1.131 | 1.834 | 3.146 |
| 5 | 0.576 | 1.005 | 1.714 |
| 6 | 0.627 | 1.207 | 2.035 |
| 7 | 1.103 | 1.666 | 2.512 |
| 8 | 1.13 | 1.742 | 2.648 |
| 9 | 1.273 | 2.422 | 4.084 |
| 10 | 1.145 | 2.114 | 3.896 |
| 11 | 0.136 | 0.221 | 5.79 |
| 12 | 1.367 | 2.515 | 4.205 |
| 13 | 1.8 | 3.1 | 6.88 |
| 14 | 0.12 | 1.96 | 4.49 |

1.-16. (canceled)

17. A polymer emulsion composition comprising
at least one block copolymer;
at least one chain transfer agent
at least one surfactant
wherein the particles of the acrylic polymer have a measured d(0.1) value of 1 μm or more.

18. The polymer emulsion of claim 17, wherein the emulsion composition has a glass transition temperature from −60° C. to 130° C.

19. The polymer emulsion of claim 17, wherein the copolymer is an acrylic or styrene-acrylic copolymer.

20. The polymer emulsion composition of claim 17 wherein the polymer comprises the functional monomers acrylic acid, methacrylic acid, styrene, alpha-methylstyrene, hydroxyethylmethacrylate. esters of acrylic acid, or methacrylic acid.

21. The polymer emulsion of claim 17, wherein the chain transfer agent is present in an amount of from 0.01 wt. % to 1 wt. % based on the total weight of the composition.

22. The polymer emulsion of claim 17, wherein the chain transfer agent is selected from the group consisting of isooctyl mercaptopropionate (IOMPA), butylmercaptopropionate, 2-ethyl hexylmercaptopropionate, tertiary dodecylmercaptan, and thioglycerol.

23. The polymer emulsion of claim 17, wherein the surfactant is present in an amount of from 0.3 wt. % to 1 wt. % based on the total weight of the composition.

24. The polymer emulsion of claim 17, wherein the surfactant is selected from the group consisting of fatty alcohol alkoxylates, fatty alcohol ethoxylates, ethylene oxide block copolymers, propylene oxide block copolymers, alkyl sulfonates, alkyl benzene sulfonates, alkyl sulfates, alkyl benzene sulfates, phosphates, phosphinates, or fatty carboxylates.

25. The polymer emulsion of claim 17, wherein the emulsion further comprises an aqueous resin solution, rheology modifier, wetting agent, defoamer, thickener, stabilizer, buffering agent, salt, preservative, fire retardant, biocide, corrosion inhibitor, cross-linker, lubricant, colorant, dye, wax, perfume, or filler.

26. A method for producing the polymer emulsion of claim 17 in dual feed reactor comprising
(i) charging a polymerization reactor with DI-water, surfactant, and seed polymer;
(ii) adding an initiator to the reactor;
(iii) feeding monomers into the reactor from two separate tanks to form a polymer composition;
(iv) adding flush water to the reactor;
(v) chemically stripping the polymer composition; and
(vi) filtering the polymer composition into a storage container.

27. The method of claim 26, wherein the monomer feeding is ramped-up and ramped-down gradually.

28. The method of claim 26, wherein the dual power feed synthesis process produces gradient molecular weight polymeric chains.

29. The method of claim 26, wherein the dual power feed synthesis process produces a wide Tg of the resulting polymer dispersion.

30. The method of claim 26, wherein the dual power feed synthesis process produces a gradient Tg.

31. A substrate coated with the composition of claim 17.

32. An adhesive comprising the composition of claim 17.
